(19) United States
(12) Patent Application Publication
(10) Pub. No.: US 2022/0055936 A1
(43) Pub. Date: Feb. 24, 2022

(54) METHOD FOR MANUFACTURING PLATE GLASS

(71) Applicant: Yazaki Energy System Corporation, Tokyo (JP)

(72) Inventor: Takuju NAKAMURA, Tokyo (JP)

(73) Assignee: Yazaki Energy System Corporation, Tokyo (JP)

(21) Appl. No.: 17/519,903

(22) Filed: Nov. 5, 2021

Related U.S. Application Data
(63) Continuation of application No. PCT/JP2020/020140, filed on May 21, 2020.

(30) Foreign Application Priority Data
May 30, 2019 (JP) 2019-101030

(51) Int. Cl. C03B 11/12; C03B 11/08; C03B 23/02

(52) U.S. Cl. CPC C03B 11/122; C03B 11/08; C03B 2215/41; C03B 2215/69; C03B 23/02

(57) ABSTRACT

The method for manufacturing a plate glass is a method for manufacturing the plate glass having sides of at least 30 cm or more and a surface thereof on which a predetermined shape is formed. In the manufacturing method, the flat plate glass is heated to a temperature which is lower than a softening point and at which the heated flat plate glass is deformable by being pressed at a predetermined pressure or higher, the heated flat glass, which has been molded by pressing the flat plate glass with a die having a die structure for forming the predetermined shape, is cooled to the strain point while being held with the die. Further, in the manufacturing method, the pressing is performed with the die having a coefficient of thermal expansion whose difference from that of the plate glass is 2.0×10⁻⁶/K or less.

### CROSS REFERENCE TO RELATED APPLICATIONS

This application is a continuation application of International Application No. PCT/JP2020/020140, now WO 2020/241451 A1, filed on May 21, 2020, which claims priority to Japanese Patent Application No. 2019-101030, filed on May 30, 2019, the entire contents of which are incorporated by reference herein.

### BACKGROUND

### 1. Technical Field

The present invention relates to a method for manufacturing a plate glass.

### 2. Description of the Related Art

As a conventional method for manufacturing a plate glass, there is a rollout method (rolling method) in which a molten glass material is stretched between two rollers (see JP S55-109237 A (Patent Literature 1)). In the rollout method, the glass material is stretched by two rollers and then annealed. The glass material after the annealing is cut to be a plate glass of a desired size. This method is characterized in that it is easy to produce a large-sized plate glass having a side of 30 cm or more, for example. However, in this method, it is difficult to form a smooth mirror surface on the glass surface, or it is difficult to form a shape with high accuracy (a shape including unevenness or the like) on the glass surface.

Another method of manufacturing plate glass is a float method in which a molten glass material is poured onto a float bath which is a pool filled with molten tin (see JP S60-016824 A (Patent Literature 2)). In this manufacturing method, the glass material is passed through the float bath and then annealed. The glass material after annealing is cut to be a plate glass of a desired size. This method is characterized in that it is easy to produce a large-sized plate glass having a side of 30 cm or more, for example. In addition, the glass material passes through the float bath while it floats on the tin. Therefore, the surface of the glass after passing through the float bath has a high smoothness and is easy to be a mirror surface. However, due to the use of the float bath, it is impossible to form a shape with high accuracy on the glass surface.

Further, as one of the methods for forming a lens or the like, there is a method called reheat molding method or reheat pressing method (see JP 2014-196244 A (Patent Literature 3) and JP H01-212240 A (Patent Literature 4)). In this method, a glass member having the same size as the final product, which is referred to as a blank or preform, is first prepared. Thereafter, the glass member is heated to a temperature lower than the softening point and pressed with a die with a predetermined shape. The glass is then cooled to the strain point while being held in the die. In this method, the smoothness of the glass surface can be improved, and a shape with high accuracy can be formed on the glass surface. However, the above method is a method suitable for manufacturing a small glass product such as an optical component such as a lens. With this method, a large-sized plate glass having a side of 30 cm or more, for example, cannot be manufactured.

In the reheat molding, it is necessary to perform the molding at a temperature lower than the softening point in order to produce a shape with high accuracy. In this case, the heated glass is pressed at about 10 to 100 atm. However, even under such pressure, the amount (degree) of deformation of the glass is limited. Therefore, it is necessary in advance to prepare a glass material that has been melted and solidified to a shape close to the final shape, cut the required amount, and further adjusted in weight with a method such as sand polishing, in order to use it as a blank or a preform. That is, it was difficult to prepare a large blank or a preform by a method of melting and solidifying in advance.

When the glass is cooled to the strain point, the glass may stick to the die. In order to prevent the glass from sticking, the glass and the die between which there is a large difference in thermal expansion coefficients are used. However, for a large plate glass having a side of 30 cm or more, such a difference in thermal expansion coefficient causes cracking. In particular, when pressing is made to form a shape having protrusions or recesses, the glass is easily cracked due to the difference in the coefficient of thermal expansion.

It should be noted that the expression “forming a shape with high accuracy on the glass surface” means that a shape pattern having a difference of 1 mm or more between a thick part and a thin part is formed on a plate glass having a uniform thickness, and is not intendevd for forming a bent glass which is bent while keeping the thickness of the plate glass approximately constant.

### SUMMARY

According to the aforementioned methods described in Patent Literatures 1 to 4, in a large-sized plate glass, it is difficult to form a clean surface with improved smoothness (hereinafter referred to as mirror surface treatment) and realize a shape with high accuracy. For this reason, if these methods are applied in the manufacture of a window glass or the like which reflects or takes in sunlight using a shape with high accuracy, unintended reflection or taking-in of sunlight occurs.

The present invention has been made considering the above circumstances, and the object is to provide a method for manufacturing a plate glass, which is capable of forming a mirror surface and a shape with high accuracy on a surface of a large-sized plate glass, particularly the shape having protrusions or recesses, or a pattern in which a recess and a protrusion are alternately formed.

A method for manufacturing a plate glass according to the present invention is a method for manufacturing a plate glass having sides of at least 30 cm or more and a surface thereof on which a predetermined shape is formed. The method includes: heating an unformed plate glass in a state where the predetermined shape is not formed on the surface to a temperature which is lower than a softening point and at which the unformed plate glass is deformable by being pressed at a predetermined pressure or higher; molding a heated plate glass having the predetermined shape formed on a surface thereof, by pressing the heated plate glass with a die having a die structure for forming the predetermined shape; and cooling the molded plate glass to a strain point while being held with the die. Further, in the manufacturing method, the pressing is performed with the die having a coefficient of thermal expansion whose difference from that of the plate glass is 2.0×10⁻⁶/K or less. It is preferable to use a plate glass produced by a float method, as the unformed flat glass, is more preferable to use a plate glass which is a soda lime glass having a coefficient of thermal expansion of 8.5×10⁻⁶ to 10.0×10⁻⁶/K in the room temperature range.

According to the present invention, an unformed plate glass is heated to a temperature, which is higher than the strain point and lower than the softening point, and at which the unformed plate glass is deformable by being pressed at a predetermined pressure or higher. A plate glass, which has been molded by pressing the heated unformed plate glass with a die having a die structure for forming a predetermined shape, is cooled to the strain point while being held with the die. For this reason, same as the reheat molding, it is possible to maintain the shape of the plate glass until it is cooled and to perform mirror surface treatment on a surface of the plate glass and form a shape with high accuracy on the surface. Here, in the case of manufacturing a large-sized plate glass, unlike the case of manufacturing a small-sized glass material, cracking may occur in the plate glass upon cooling due to the difference in the coefficient of thermal expansion from the die. However, since pressing is performed with a mold having the coefficient of thermal expansion whose difference from that of the plate glass is 2.0×10⁻⁶/K or less at the strain point, such concern is eliminated in the fourth step of cooling. Accordingly, it is possible to perform mirror surface treatment on a surface of a large-sized plate glass and form a shape with high accuracy on the surface.

### BRIEF DESCRIPTION OF THE DRAWINGS

FIG. 1 is a perspective view showing an example of a plate glass manufactured by a method for manufacturing plate glass according to an embodiment of the present invention.

FIGS. 2A to 2D are a flow sheet showing the method for manufacturing a plate glass according to the present embodiment, wherein FIG. 2A shows a first step, FIG. 2B shows a second step,

FIG. 2C shows a third step, and FIG. 2D shows a fourth step.

### DESCRIPTION OF THE EMBODIMENTS

Hereinafter, several embodiments according to the present invention will be described. It should be noted that the present invention is not limited to the embodiments described below, and may be appropriately modified within a range not departing from the scope of the present invention. In the embodiments described below, an illustration or explanation about some of the configurations is not omitted. However, the details of the omitted techniques can apply publicly known or well-known techniques as far as there is no conflict between the contents described below and the applied techniques.

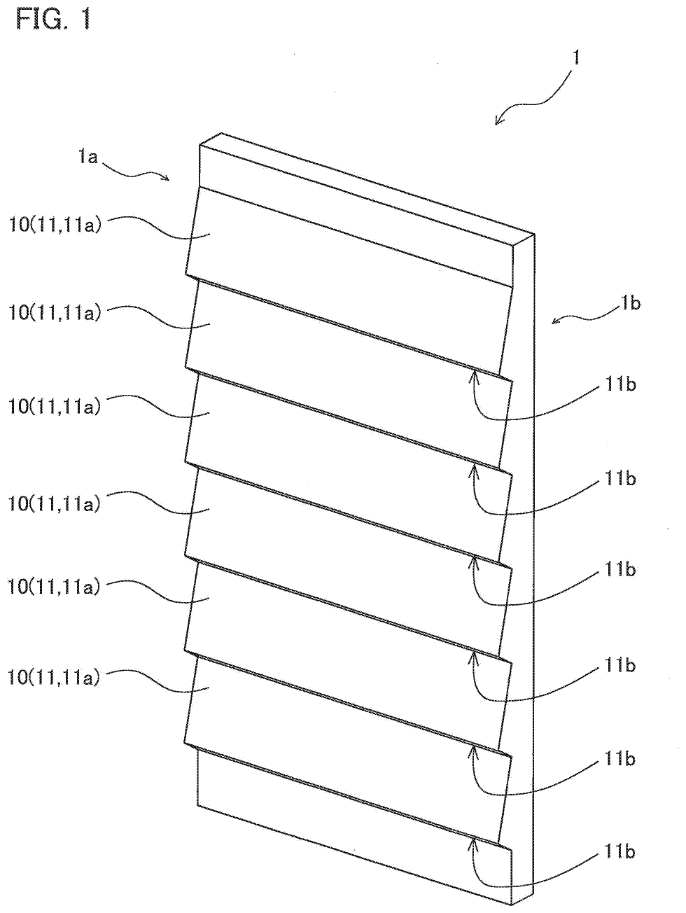

FIG. 1 is a perspective view showing an example of a plate glass 1 manufactured by a manufacturing method according to an embodiment of the present invention.

The plate glass 1 is a large plate glass having sides of at least 30 cm, preferably having sides of 60 cm or more, and more preferably having sides of 1 m or more. In the plate glass 1, for example, a predetermined shape 10 is formed on one side surface 1a, and the other side surface 1b is flat. That is, the plate glass 1 is a flat plate glass to which a predetermined shape 10 is additionally formed.

As shown in FIG. 1, the predetermined shape 10 includes triangular prisms 11 projecting from a surface1a of the plate glass 1. Each triangular prism 11 has a first surface 11a and a second surface 11b. The first surface 11a and the second surface 11b are inclined with respect to the normal direction of the plate glass 1 and are perpendicular to each other, for example. In this case, when viewed from the side surface of the plate glass 1, Each triangular prism 11 has a cross section of a right triangle with a top of right angle protruding. A reflective surface by silver plating may be formed on the first surface 11a and the second surface 11b. The triangular prisms 11 are continuously arranged.

The surface 1a (first surface 11a and second surface 11b) on one side and the surface 1b on the other side have high smoothness and are processed with mirror surface treatment. The plate glass 1 functions as an optical lens (optical prism) capable of suitably reflecting and taking in sunlight using the predetermined shape 10. The thickness (maximum value) of the plate glass 1 is, for example, about 2 to 20 mm. The predetermined shape 10 may be formed not only on the surface la on one side but also on the surface 1b on the other side.

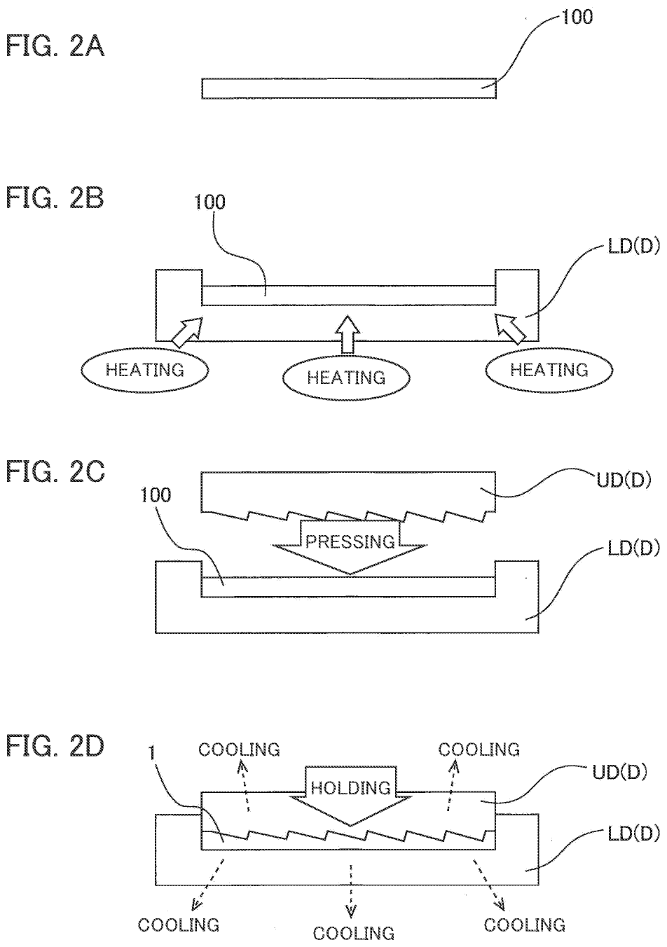

FIGS. 2A to 2D are a flow sheet showing a method of manufacturing the plate glass 1 according to the present embodiment, wherein FIG. 2A shows a first step, FIG. 2B shows a second step, FIG. 2C shows a third step, and FIG. 2D shows a fourth step.

First, as shown in FIG. 2A, a flat plate glass 100 which is an unformed plate glass (untreated glass) is prepared (first step). The flat plate glass 100 has the same size as the plate glass 1. However, the predetermined shape 10 is not yet formed on the flat plate glass 100. In the first step, not only the flat plate glass 100 but also a non-flat plate glass having some unevenness may be prepared unless a predetermined shape 10 is formed on the surface thereof. That is, in the first step, it is preferable to prepare an unformed plate glass having a shape as close as possible to the glass material to be the final shape. In the first step, glass, which does not require a high heating temperature as possible and does not have a relatively large thermal expansion coefficient in the below-mentioned second step, may be selected as the untreated glass. However, glass such as the so-called blue plate or white plate made of soda lime glass, which requires a relatively high heating temperature and has a relatively large thermal expansion coefficient, may be selected.

Next, as shown in FIG. 2B, the flat plate glass 100 is heated in a state where it is mounted on the lower die (mold) LD (second step). In the second step, the flat plate glass 100 is heated to a temperature (e.g., around 690° C.), which is higher than the strain point (e.g., 500° C.) of the material of the flat plate glass 100 and lower than the softening point (e.g., 720° C.) thereof, and at which can be changed in shape by pressing at a predetermined pressure (e.g., about 2.5 MPa depending on the temperature) or higher. The flat plate glass 100 is heated such that the temperature substantially uniformly raises.

Thereafter, as shown in FIG. 2C, in a state where the flat plate glass 100 has been heated, the upper die (mold) UD presses the flat plate glass 100 at a predetermined pressure or higher to perform pressing (third step). The upper die UD has a die structure corresponding to the predetermined shape 10 (see FIG. 1). By press molding to the flat plate glass 100, a plate glass 1 having the predetermined shape 10 is manufactured. The upper die UD has a surface with high smoothness so that the smoothness of the first surface 10a and the second surface 11b of the predetermined shape 10 is high accordingly. This point is the same for the lower die LD.

Next, as shown in FIG. 2D, the plate glass 1 is cooled to the strain point (for example, 500° C.) while being held by the upper die UD and the lower die LD (fourth step). The cooling here is annealing by natural cooling.

When the plate glass 1 is annealed to the strain point, the plate glass 1 is removed from the die (mold) D and is cooled outside the die D.

In the manufacturing method described above, the upper die UD and the lower die LD hold the plate glass 1 until it is cooled. Therefore, it is possible to easily form an accurate shape and to perform mirror surface treatment. Thus, it is possible to process the mirror surface treatment to the plate glass 1 and to form a shape with high accuracy.

When relatively large plate glass 1 would be manufactured, the plate glass 1 might be broken while being cooled from the heating temperature in the heating step to the strain point. For example, it is assumed that the large plate glass 1 of 1 m×2 m is manufactured. In this case, if there is a difference of 2.0×10⁻⁶/K between the expansion coefficiencies of the die D having a length of 2 m and the plate glass 1, a difference of 0.8 mm in length would be caused by cooling by about 200° C. (i.e., cooling from about 690 to 500° C.). When a difference in length exceeding this value would occur, the plate glass 1 would be cracked. In particular, when the shape to be molded has a plurality of recesses or projections and the thermal expansion coefficient of the plate glass 1 is larger than that of the die D, the plate glass is likely to crack because the die D and the plate glass 1 grip each other and tensile stress is generated in the plate glass 1.

Therefore, in the third step according to the present embodiment, the pressing is performed with the die D having a predetermined thermal expansion coefficient. The predetermined thermal expansion coefficient of the die D is a thermal expansion coefficient in which the difference of thermal expansion of the die D from the thermal expansion coefficient of the plate glass 1 at the strain point of the plate glass 1 is 2.0×10⁻⁶/K or less in the temperature range between the molding temperature and the strain point of the plate glass. Thus, the plate glass can be prevented from cracking. The predetermined thermal expansion coefficient of the die D is preferably larger than the thermal expansion coefficient of the plate glass 1 at the strain point of the plate glass 1 in a range of 0 to 2.0×10⁻⁶/K in a temperature range between the molding temperature and the strain point of the plate glass 1. In this case, the shrinkage amount of the die D while the annealing is slightly larger than the shrinkage amount of the plate glass 1. Therefore, a proper range of compressive force is applied to the plate glass 1. In other words, it is possible to prevent (avoid) the tensile force, which causes cracks, from being applied to the glass, which is weak against tensile force.

Generally, a temperature of glass between a strain point thereof and a softening point thereof is referred to as a transition point. The thermal expansion coefficient drastically varies below and above the transition point. The thermal expansion coefficient is almost constant in a temperature range from room temperature to the strain point, which is lower than the transition point. However, the transition point is easily fluctuated by heat treatment or the like, and it is difficult to specify the transition point. For this reason, the specific temperature of the transition point cannot be exemplified, but the temperature in the molding according to the present embodiment is close to the softening point. Therefore, the temperature of the glass passes this transition point during annealing after molding. Since the glass has fluidity at temperatures above the transition point, cracks due to differences in thermal expansion during annealing are unlikely to occur. On the other hand, since cracks tend to occur at temperatures below the transition point, the thermal expansion coefficient of the glass at the strain point is compared with the thermal expansion coefficient of the die.

In the present embodiment, a float glass is assumed as the flat plate glass 100. The float glass is relatively inexpensive and is processed with mirror surface treatment. As the float glass, there are so-called a blue plate (blue plate glass) made of soda-lime glass and so-called a white plate (white plate glass) made with low iron content. The thermal expansion coefficients of the blue and white plates are 8.5×10⁻⁶ to 10.0×10⁻⁶/K from room temperature to the strain point, more typically 9.0×10⁻⁶ to 9.5×10⁻⁶/K. The strain point is about 450 to 520° C., and the softening point is about 690 to 730° C.

On the other hand, the thermal expansion coefficient of a general metal material of a die, which can be formed by casting, at around 500° C. is larger than that of the float glass. For example, the thermal expansion coefficient of martensitic stainless steel, which is a general die material, at around 500° C. is 13×10⁻⁶/K or more. On the contrary, when the die material would be a high-melting-point material, a combined material of materials having low miscibility (compatibility), or the like, the thermal expansion coefficient at around 500° C. is smaller than that of the float glass. For example, the thermal expansion coefficient of the cemented carbide is 7×10⁻⁶/K or less, and the thermal expansion coefficient of the silicon carbide is 3.9×10⁻⁶/K. It is known that iron-nickel-based alloys such as Invar, which combines iron and nickel, and Super Invar, which combines iron, nickel and cobalt, can be cast, but the thermal expansion coefficients can be specifically suppressed because of cancellation of the expansion of the interatomic distance and the contraction of the atomic radius. However, since the thermal expansion coefficients are smaller than that of the glass to be formed, Invar and the like cannot be used in the temperature range of 500 to 700° C.

Ceramics based on metal oxides such as alumina and zirconia similarly have thermal expansion coefficients close to that of glass, which is a metal oxide. However, the processing of ceramics is difficult. In addition, since the ceramic has hydroxyl groups on its surface, it is easy to bond between metal oxides and has poor die releasability. Therefore, a special die material is used for the die D according to the present embodiment. A die made of cermet or other ceramic material is also referred to as a die.

Materials of the die D according to the present embodiment include the following. However, the materials are not limited to these:
Cemented carbide having a large thermal expansion coefficient obtained by increasing a binder, or cermet having a large thermal expansion coefficient (JP 2016-125073 A and JP 2017-206403 A)
Some ceramics such as metal oxides, nitrides, borides, silicides or the like,
Material with a thermal expansion coefficient adjusted by dispersion of Fluorophlogopite mica crystals into a glass matrix,
Platinum-group or platinum-group alloy having a thermal expansion coefficient close to Soda-Lime glass alone, and chromium or Chromium-Containing alloy
Molybdenum-containing alloy or tungsten-containing alloy in which iron having a large thermal expansion coefficient is combined with metal having a small coefficient of thermal expansion, or the like. (As concrete examples of these: WC-40% CO cemented carbide made by Fuji Die Co., Ltd., chromium carbide base alloy made by Fuji Die Co., Ltd., KF alloy made by Fuji Die Co., Ltd., Incoloy 909, HRA929 made by Hitachi Metals, chromium silicide, macellite made by Krosaki Harima Corporation, or the like.)

Further, in the third step according to the present embodiment, it is preferable to press with a die D having high die releasability on the contact surface of the die D with the plate glass 1 or a die D1 processed with surface treatment for enhancing the die releasability.

In the conventional reheat molding (reheat press method), it is known that the die releasability deteriorates as the pressure of pressing increases and as the contact time between the die and the glass material increases. Therefore, in the conventional reheat molding, when a small glass member is manufactured, a sufficient difference in thermal expansion coefficient is secured between the die and the glass material to prevent sticking of the die and the glass material. On the other hand, in the manufacturing method of the large plate glass 1 according to the present embodiment, the difference in thermal expansion coefficient is small. Therefore, there is a concern that the plate glass 1 is easy to stick to the die D. In particular, in the case of manufacturing the large plate glass 1, heating and cooling are performed more slowly than in the case of manufacturing the small plate glasses, so that there is a concern that the sticking is further promoted.

Therefore, in the present embodiment, the contact angle between the molten glass and the surface of the die D is preferably 70 degrees or more, and more preferably 90 degrees or more. When the base material of the die D is subjected to the surface treatment, the thermal expansion coefficient of the surface treatment is preferably 2.0×10 ⁻⁶/K or less different from the thermal expansion coefficients of the plate glass 1 and the base material of the die D. In this way, by pressing with the die D having high die releasability or processed with surface treatment for enhancing the die releasability, the sticking problem is solved, and the plate glass 1 can be easily removed from the die D.

Specific examples of the above surface treatment are as follows. The surface processed with these treatments specifically has poor wettability of molten glass and little possibility of sticking. However, the above surface treatment is not limited to the following treatments.
Platinum group based plating or gold alloy plating (see JP 2001-278631 A)
Plating treatment such as hard gold plating or chrome plating
Deposition treatment of Chromium-Based alloy
Formation of superhard films such as metal nitrides, borides, carbides, and silicides

Platinum group metals are known to be less wettable to molten glass. For example, platinum and rhodium alone have (cause) contact angles of more than 70 degrees. A small amount of gold may be added to these platinum group metals. The contact angle can be further increased by adding gold. It is known that gold alone has a contact angle of about 160 degrees. Therefore, gold alloy plating, which contains gold as a main component and has improved hardness or the like, may be used. It is preferable that the particle size of these metals is small as possible. By reducing the particle size, the hardness of the plating can be increased and the friction coefficient can be reduced. Amorphous plating can further increase hardness and reduce the friction coefficient.

When the material of the die D is chromium or a chromium-based alloy, plating treatment of chromium plating or vapor deposition treatment of the chromium-based alloy is preferable.

An example of a nitride is CrAlSiN. CrAlSiN has a contact angle of about 80 degrees. Other examples of nitrides are chromium nitride and chromium silicide. These have a contact angle of about 120 degrees or more (see JP 2007-84411 A). Alternatively, it may be a glass ceramic containing fluorophlogopite crystals or a molded product obtained by mixing a chromium compound with fluorophlogopite crystals. These are known to have low glass wettability (see JP H06-64937 A). Metallic chromium, chromium alloys, platinum, platinum alloys, chromium silicide, and glass ceramics containing fluorophlogopite mica crystals, and those formed by mixing chromium compounds in the above-mentioned glass ceramics are all particularly preferable since their thermal expansion coefficients are close to those of glass. These may be used as a die base material or as a thin film on a die surface formed by overlaying or surface treatment of a die made of a die base material having a suitable thermal expansion coefficient but poor releasability.

In the present embodiment, the flat plate glass 100 having no predetermined shape is heated to a temperature, which is lower than the softening point, and at which the flat plate glass 100 is deformable by being pressed at a predetermined pressure or higher. The heated flat plate glass 100 is pressed and molded with the die D having the die structure for forming the predetermined shape 10. Further, the heated and molded plate glass 1 is cooled to the strain point while being held by the die D. Same as the reheat molding, the shape of the plate glass 1 is maintained until it is cooled. Therefore, it is possible to perform mirror surface treatment on a surface of the plate glass 1 and form a shape with high accuracy on the surface. Further, pressing is performed with the die D having the coefficient of thermal expansion whose difference from that of the plate glass 1 is 2.0×10⁻⁶/K or less at the strain point. Accordingly, the concern about cracking that was likely to occur during cooling of the large-sized plate glass (that is, the fourth step in the present embodiment) is also eliminated. Consequently, it is possible to perform mirror surface treatment on the surface of the large-sized plate glass and form the shape with high accuracy on the surface.

Pressing is performed with the die D processed with surface treatment for enhancing die releasability on the contact surface of the die D with the plate glass 1. Therefore, it is possible to suppress deterioration of the die releasability due to a small difference in thermal expansion coefficient between the plate glass 1 and the die D, thereby easily removing the plate glass 1.

Pressing is performed with the die D which causes the contact angle on its contact surface (treated surface if the surface treatment has been processed) with the molten plate glass (the plate glass 1 in a molten state) is 70 degrees or more. Therefore, it is possible to suppress sticking of the plate glass 1 to the die D, thereby easily removing the plate glass 1.

Although the present invention has been described based on the embodiments described above, the present invention is not limited to the embodiments described above, and may be modified without departing from the scope of the present invention, or may be combined with known or well-known techniques as appropriate to the extent possible.

For example, in the above embodiment, the die D is made of a base material having a high releasability or is subjected to a surface treatment to enhance the releasability, but it is not limited to this, and other means may be employed such as making the plate glass 1 easy to be removed from the die D by blowing air or inert gas without being subjected to the surface treatment.

Further, although the predetermined shape 10 of the plate glass 1 is triangular prisms 11 in the above embodiment, it is not limited to this and other shapes may be used.

Although some embodiments of the present invention have been described above, these embodiments are presented as examples and are not intended to limit the scope of the invention. These new embodiments may be implemented in various other forms, and various omissions, substitutions, and modifications may be made without departing from the spirit and scope of the invention. These embodiments and modifications thereof are included in the scope and the gist of the invention and are included in the scope of the claimed invention and the equivalent thereof.

What is claimed is:

1. A method for manufacturing a plate glass having sides of at least 30 cm or more and a surface thereof on which a predetermined shape is formed, comprising:
a first step of preparing an unformed plate glass in a state where the predetermined shape is not formed on the surface;
a second step of heating the unformed plate glass to a temperature which is lower than a softening point and at which the unformed plate glass is deformable by being pressed at a predetermined pressure or higher;
a third step of molding a heated plate glass having the predetermined shape formed on a surface thereof, by pressing the heated unformed plate glass with a die having a die structure for forming the predetermined shape; and
a fourth step of cooling the plate glass in a heated state to a strain point while being held with the die; wherein,
the pressing in the third step is performed with the die having a coefficient of thermal expansion whose difference from that of the plate glass is 2.0×10⁻⁶/K or less.

2. The method according to claim 1, wherein
the pressing in the third step is performed with the die processed with surface treatment for enhancing die releasability on a contact surface of the die with the plate glass.

3. The method according to claim 1, wherein
the pressing in the third step is performed with the die which causes a contact angle on the contact surface of the die with the molten plate glass is 70 degrees or more.
